(19) United States
(12) Patent Application Publication
(10) Pub. No.: US 2012/0308840 A1
(43) Pub. Date: Dec. 6, 2012

(54) FORMULATION AND USE THEREOF

(76) Inventors: Michael Maier, Marxzell (DE); Jörg Habicht, Sinzheim (DE); Alexander Kraus, Pittenhart (DE); Andrey Karpov, Metuchen, NJ (US); Frank Rosowski, Berlin (DE); Frank Müller, Ludwigshafen (DE)

(21) Appl. No.: 13/518,768

(22) PCT Filed: Dec. 13, 2010
(86) PCT No.: PCT/EP10/69446

§ 371 Date: Aug. 23, 2012

(30) Foreign Application Priority Data
Jan. 4, 2010 (EP) 10150026.2

(51) Int. Cl. A01N 59/20; B32B 21/00; A01P 3/00; A01N 25/04; A01P 7/04; A01N 59/26

(52) U.S. Cl. 428/541; 424/638; 424/633; 424/604; 424/632; 424/635; 424/637; 424/405; 424/634

(57) ABSTRACT

A formulation is claimed, which contains at least one protective substance that is active with respect to cellulose-containing materials, such as wood-containing building materials in the form of solid wood or wood-based materials, and at least one specific compound with dispersing properties. The dispersants are branched comb-shaped polymers with polyether side chains, naphthalene-sulfonate-formaldehyde condensation products, melamine-sulfonate-formaldehyde condensation products and phosphatized polycondensation products. The formulations according to the invention are suitable in particular as plant protection agents and wood preservatives and are preferably used in the form of suspensions for pressure treatment of the respective building materials.

The present invention relates to a formulation containing at least one protective substance that is active with respect to cellulose-containing materials and the use thereof.

Wood in particular, as an important building and constructional material, is subjected to weathering and temperature effects, wherein varying temperature and moisture conditions promote the destructive action of bacteria, fungi and insects.

The use of metal-containing and in particular metal salt-containing formulations has been well known for many decades in this connection for impregnating and protecting wood-containing materials and in particular building materials.

In particular, the use of copper-containing wood preservatives is said to protect the degradation of the cellulose or lignin constituents of wood by fungi and insects.

Through the development of novel wood-based building materials, impregnating and preventive wood protection has gained importance especially in the last decade. In particular the protection of wood fiberboard and solid-wood boards has come to the fore. In the case of treatment with metal-containing wood preservatives, moreover, the preventive protection of wood against wood destroying fungi and insects has come to the fore.

Important representatives of fungi, which attack the cell wall constituents cellulose, hemicelluloses and lignins of wood, are the wood discoloring and destroying representatives of the brown rot fungi, white rot fungi and the mildew fungi. The optimal growth conditions of the wood-destroying fungi are in the temperature range between 0 and 40° C. and wood moisture content from 20 to 100%. Depending on the species of fungus, only certain wood species or mainly the sapwood or heartwood are attacked.

In the case of wood-destroying insects, a distinction is to be made between the insects that live in the wood, establish breeding places there, and raise the brood, and those that use the wood as a food source. Fresh-wood insects live for example in freshly felled lumber and in lumber yards. Dry-wood insects occur on and in air-dry lumber or lumber that is dry and ready for use, stored in the open, and in and on buildings. As a rule these insects require a wood moisture content of at least 10% and temperatures between 10 and 38° C.

The wood preservatives suitable for combating them are usually assigned to three main categories, which depend on the respective solvent media. Thus, a distinction is made between water-based, oil-based and creosote-oil (tar-oil)-based systems.

Water-based wood preservatives comprise chromium-copper arsenates (CCA), ammoniacal copper quat compounds (ACQ), and alternative combinations of active substances based on copper and additional co-biocides. Lumber treated with these representatives shows greenish to gray-green staining after the treatment, owing to the chemical reaction between the copper components of the wood preservative and the ultraviolet radiation of sunlight. The disadvantage with these representatives is their wash-out and leaching behavior, in particular regarding the chromium components, which may pollute the soil and groundwater. In contrast, the creosote-oil-containing wood preservatives do not have any pronounced wash-out behavior. Moreover, these agents do not corrode metals. The disadvantage with these systems, however, is that they are not compatible with paints and, owing to their bitumen content, always have a dark coloration and moreover give off a repulsive odor. The oil-based systems generally contain light oils, such as pentachlorophenol, copper naphthenates and copper-8-quinolinolates. Lumber treated with these agents also has a surface that cannot be painted, which is also dark colored and moreover has unnatural color shades.

Most wood preservatives of the newer generation have soluble copper compounds, for example copper alkanolamine complexes, copper polyaspartic acid complexes, alkaline quaternary copper compounds, copper azoles, copper-boron azoles, copper bis(dimethyldithiocarbamate), ammoniacal copper citrates, copper citrates and copper ethanolamine carbonates.

A disadvantage with all these preservatives with soluble copper components is the need to combine them with organic biocides, to achieve a biological spectrum of action that is as broad as possible. Therefore there have been attempts to combine, as further representatives of biocides, oil soluble biocides with the copper compounds. In this connection we may mention for example copper(II)-sulfited tannin extract complexes, so-called epicatechins, which can be dissolved in oils, emulsified in water and thus injected into the xylem. Representatives of the triazole group, as well as quaternary amines and cyclohexyldiazenium dioxide compounds are either water-soluble or emulsifiable and therefore are also very suitable for combining with the aforementioned copper compounds.

In particular, there has been notable improvement in the application properties of chromatized copper arsenates (CCA). Reference should be made in particular to patent EP 1 651 401 B1, in which wood preservatives are described that contain copper compounds in particle form, and a method of production thereof:

The wood preservative composition described comprises in particular a plurality of ground particles, which consist essentially of a combination of sparingly soluble copper salts with sparingly soluble zinc salts and primarily have an average diameter of less than 0.5 μm. In addition to these metal salts, the preservative composition described here contains at least one corrosion inhibitor and optionally polymers.

U.S. Pat. No. 6,500,871 B1 describes a method for producing particle-containing colloids, which can be attributed to the hydrolysis of metal-containing salts. In order to stabilize these colloids in aqueous dispersions, the starting compounds in the form of mineral salts of cationic metals are introduced into an aqueous solution, then the resultant product is complexed with the aid of a water-soluble block copolymer and finally hydrolysis is carried out, with control of particle growth. A suitable metal cation for this method is copper, and it is noted quite generally that such colloids can be used in dispersions with fungicidal or biocidal action.

The international patent application PCT/EP2009/058303 dated Feb. 7, 2009 of BASF SE, Ludwigshafen, not previously published, relates to a method for producing surface-modified and nanoparticulate copper compounds and aqueous suspensions containing them. The claimed method essentially comprises a sequence of four process steps, envisaging using polycarboxylates as water-soluble polymers and in particular polycarboxylate ethers, which are commercially available under the trade name Sokalan from BASF SE. Besides these ionic representatives, nonionic water-soluble polymers are also described, which are available under the designation Cremophor. The use of the polycarboxylates with dispersant action is limited in this connection to the homogeneous and finely-divided distribution of the copper compounds in suspensions.

Protective agents for cellulose-containing materials and in particular wood preservatives are therefore known from the prior art, which in addition to the metal-containing biocidal active substances contain nonionic and/or low-molecular dispersants. Therefore the problem to be solved by the present invention was to provide a new formulation, containing at least one protective substance that is active with respect to cellulose-containing materials and at least one compound with dispersing properties. This formulation should be suitable for use as plant protection agent or wood preservative, should not cause any unnatural staining in and on the treated materials and moreover should offer the possibility of further treatment of the materials treated with the new formulation, for example on their surfaces, and in particular produce any shades of color. In particular when used as wood preservative, the active constituents of the new formulation should be able to penetrate as deeply as possible and sustainably in the wood structures, should be subject to as little wash-out as possible and in particular, owing to the finely divided structure of the metal constituents present in the formulations, should guarantee homogeneous distribution in the wood material.

This problem was solved with a corresponding formulation, in which the compound with dispersing properties is at least one representative selected from the group a) compound at least containing a branched comb-shaped polymer with polyether side chains, naphthalene-sulfonate-formaldehyde-condensate (“BNS”) and melamine-sulfonate-formaldehyde-condensate (“MSF”), and b) a polycondensation product containing

(I) at least one structural unit having an aromatic or heteroaromatic and a polyether side chain and

(II) at least one phosphatized structural unit having an aromatic or heteroaromatic and

(III) at least one structural unit having an aromatic or heteroaromatic,

wherein structural unit (II) and structural unit (III) differ exclusively in that the OP(OH)₂ group of structural unit (II) is replaced with H in structural unit (III) and structural unit (III) is different from structural unit (I).

In addition to solving all the individual problems, it was found, surprisingly, that through the use of the claimed dispersants, the claimed formulations have improved stability and that owing to this, the solids content in the formulations can also be increased, and it should be pointed out in particular that the finely-divided particles of active substance can, through interaction with the dispersants, penetrate very deeply and uniformly into the cellulose-containing material and in particular into the wood structures, wherein evidently the dispersants improve passage through the pores and at the same time reduce the wash-out behavior, so-called leaching.

Formulations in which the protective substance that is active with respect to cellulose-containing materials is at least one physiologically active and preferably inorganic compound have proved to be particularly suitable. Copper compounds, preferably in nanoparticulate form, are especially suitable.

Suitable representatives of the copper compounds correspond to the general formula

[Cu²⁺]₁₋ₓ[M^{k+}]ₓ[Xⁿ⁻]ₐ[Y^{m-}]_{b}.eH₂O,

wherein

M^{k+} is a metal ion of valence k,

0≦x≦0.5,

Xⁿ⁻ is at least one inorganic anion with average valence n, which forms a solid with copper ions in water,

Y^{m-} is one or more organic anions with the valence m,

a≧0, b≧0 and the ratio of a, b and x depends on the valences k, n and m according to the formula a·n+b·m=2·(1−x)+x·k,

e≧0.

The valences of the aforementioned ions are of course integers.

The metal ions M^{k+} can for example be ions of alkaline-earth or transition metals, preferably magnesium, calcium, chromium, cobalt, nickel, zinc or silver ions, with zinc or silver ions especially preferred. The metal ions M^{k+} are present in a smaller number than the copper ions (0≦x≦0.5). The anions Xⁿ⁻ and Y^{m-} can for example be anions of mineral acids such as hydrochloric acid, sulfuric acid, phosphoric acid, carbonic acid, boric acid, sulfurous acid etc. or anions of organic acids such as oxalic acid, benzoic acid, maleic acid etc. and polyborates such as B₄O₇²⁻. Y^{m-} can also be a hydroxide ion or else a carboxylate-containing anion, in particular in high-molecular mixtures. If the stated copper compounds with the stated general formula are in an aqueous medium, preferably e=0.

It should also be pointed out that the inorganic anions Xⁿ⁻ form, with copper ions in water, a solid in the form of “turbid matter”. Formation of the solid in particular in very finely divided and/or amorphous form can therefore be determined from the formation of turbidity in conjunction with its light scattering.

In a preferred embodiment of the invention x=0. In another preferred embodiment of the invention Xⁿ⁻ is selected from the group consisting of carbonate, phosphate, hydrogen phosphate, oxalate, borate or tetraborate and hydroxide ions and any mixtures thereof.

Preferred copper compounds are selected from the group of sparingly soluble copper salts, wherein in particular copper hydroxide, copper borate, basic copper borate, copper carbonate, basic copper carbonate, tribasic copper sulfate, copper oxychloride, alkaline copper nitrate, copper-iron(III) cyanide, copper-iron(III) cyanate, copper fluorosilicate, copper thiocyanate, copper diphosphate, copper boride, copper phosphate and copper oxide may come into consideration.

In a preferred variant the physiologically active compound is at least one copper compound that has been surface-modified. This modification of the surface can preferably, in the context of the present invention, be achieved by the influence of a compound with dispersing properties and in particular with dispersants, which are described in more detail below. On the whole, however, it can be stated regarding the compounds with dispersing properties that may come into consideration in this connection that they are preferably water-soluble.

A “water-soluble polymer” means, in the context of this invention, a polymer of which, at room temperature, in general at least 0.01 wt. % dissolves in water and which forms, up to a concentration of 50 wt. % in water, preferably 75 wt. % in water, a clear single-phase solution without turbidity. The at least one water-soluble polymer serves for surface modification of the copper compounds and helps to stabilize these in nanoparticulate form.

The water-soluble polymers to be used according to the invention can be anionic, cationic, nonionic or zwitterionic polymers. Their molecular weight is generally in the range from about 800 to about 500 000 g/mol, preferably in the range from about 1000 to about 30 000 mol. They can be homo- or copolymers and their molecular structure can be both linear and branched. Water-soluble polymers with a comb-like structure are preferred.

Suitable monomers from which the water-soluble polymers to be used according to the invention can be obtained comprise for example α,β-unsaturated carboxylic acids and esters, amides and nitriles thereof, N-vinylcarboxylic acid amides, alkylene oxides, unsaturated sulfonic acids and phosphonic acids and amino acids.

In one embodiment of the invention, polycarboxylates are used as water-soluble polymers. Polycarboxylates are, in the context of this invention, polymers based on at least one α,β-unsaturated carboxylic acid, for example acrylic acid, methacrylic acid, dimethacrylic acid, ethacrylic acid, maleic acid, citraconic acid, methylene-malonic acid, crotonic acid, isocrotonic acid, fumaric acid, mesaconic acid and itaconic acid. Polycarboxylates based on acrylic acid, methacrylic acid, maleic acid or mixtures thereof are preferably used.

The proportion of the at least one α,β-unsaturated carboxylic acid in the polycarboxylates is as a rule in the range from 20 to 100 mol. %, preferably in the range from 50 to 100 mol. %, especially preferably in the range from 75 to 100 mol. %.

The polycarboxylates to be used according to the invention can be used both in the form of the free acid and partially or completely neutralized in the form of their alkali-metal, alkaline-earth metal or ammonium salts. However, they can also be used as salts of the particular polycarboxylic acid and triethylamine, ethanolamine, diethanolamine, triethanolamine, morpholine, diethylenetriamine or tetraethylenepentamine.

In addition to the at least one α,β-unsaturated carboxylic acid, the polycarboxylates can also contain further comonomers, which are polymerized into the polymer chain, for example the esters, amides and nitriles of the aforementioned carboxylic acids such as acrylic acid methyl esters, acrylic acid ethyl esters, methacrylic acid methyl esters, methacrylic acid ethyl esters, hydroxyethyl acrylate, hydroxypropyl acrylate, hydroxybutyl acrylate, hydroxyethylmethacrylate, hydroxypropylmethacrylate, hydroxyisobutyl acrylate, hydroxyisobutylmethacrylate, maleic acid monomethyl esters, maleic acid dimethyl esters, maleic acid monoethyl esters, maleic acid diethyl esters, 2-ethylhexyl acrylate, 2-ethylhexylmethacrylate, acrylamide, methacrylamide, N-dimethylacrylamide, N-tert-butylacrylamide, acrylonitrile, methacrylonitrile, dimethylamino-ethyl acrylate, diethylamino-ethyl acrylate, diethyl-amino-ethylmethacrylate and the salts of the last-mentioned basic monomers with carboxylic acids or mineral acids and the quaternized products of the basic (meth)acrylates.

Moreover, other suitable comonomers that can be incorporated by polymerization are allylacetic acid, vinylacetic acid, glycolic acid acrylamide, vinylsulfonic acid, allylsulfonic acid, methallylsulfonic acid, styrene-sulfonic acid, acrylic acid-(3-sulfopropyl)ester, methacrylic acid-(3-sulfopropyl)ester or acrylamidomethylpropanesulfonic acid and monomers containing phosphonic acid groups such as vinylphosphonic acid, allylphosphonic acid or acrylamidomethanepropanephosphonic acid. The monomers containing acid groups can be used during polymerization in the form of the free acid groups and in a form neutralized partially or completely with bases.

Other suitable copolymerizable compounds are N-vinylcaprolactam, N-vinylimidazole, N-vinyl-2-methylimidazole, N-vinyl-4-methylimidazole, vinyl acetate, vinyl propionate, isobutene, styrene, ethylene oxide, propylene oxide or ethylenimine and compounds with more than one polymerizable double bond, for example diallylammonium chloride, ethylene glycol dimethacrylate, diethylene glycol diacrylate, allylmethacrylate, trimethylolpropanetriacrylate, triallylamine, tetraallyloxyethane, triallylcyanurate, maleic acid diallyl ester, tetraallylethylenediamine, divinylidene-urea, pentaerythritoldi-, pentaerythritoltri- and pentaerythritoltetraallyl ether, N,N′-methylene bisacrylamide or N,N′-methylene bismethacrylamide.

It of course also possible to use mixtures of the aforesaid comonomers. For example, mixtures of 50 to 100 mol. % acrylic acid and 0 to 50 mol. % of one or more of the aforementioned comonomers are suitable for producing the polycarboxylates according to the invention.

In a preferred embodiment of the invention, polycarboxylate ethers are used as water-soluble polymers.

A great many of the polycarboxylates to be used according to the invention are commercially available under the trade name Sokalan® (from BASF SE).

In further embodiments of the invention the water-soluble polymer is polyaspartic acid, polyvinylpyrrolidone or copolymers of an N-vinylamide, for example N-vinylpyrrolidone, and at least one other monomer containing polymerizable groups, for example with monoethylenically unsaturated C₃-C₈-carboxylic acids such as acrylic acid, methacrylic acid, C₈-C₃₀-alkyl esters of monoethylenically unsaturated C₃-C₈-carboxylic acids, vinyl esters of aliphatic C₈-C₃₀-carboxylic acids and/or with N-alkyl- or N,N-dialkyl-substituted amides of acrylic acid or of methacrylic acid with C₈-C₁₈-alkyl residues.

A preferred embodiment of the method according to the invention is characterized in that polyaspartic acid is used as water-soluble polymer. The term polyaspartic acid comprises, in the context of the present invention, both the free acid and the salts of polyaspartic acid, e.g. sodium, potassium, lithium, magnesium, calcium, ammonium, alkylammonium, zinc and iron salts or mixtures thereof.

In another embodiment of the invention, nonionic water-soluble polymers are used. A nonionic water-soluble polymer means, in the context of this invention, surface active substances whose chemical structure comprises between 2 and 1000 —CH₂CH₂O— groups, preferably between 2 and 200 —CH₂CH₂O— groups, especially preferably between 2 and 80 —CH₂CH₂O— groups. These groups form for example by addition of a corresponding number of ethylene oxide molecules onto substrates containing hydroxyl or carboxyl groups and as a rule form one or more continuous ethylene glycol chains whose chemical structure corresponds to the formula —(—CH₂CH₂O—)ₙ— with n from approx. 2 to approx. 80.

The surface modification of the copper compound can preferably be achieved, in the context of the present invention, with a method comprising the steps:
a) preparing an aqueous solution containing copper ions (solution 1) and an aqueous solution containing at least one anion that forms a turbid matter with copper ions (solution 2), wherein at least one of the two solutions 1 and 2 contains at least one processing aid with dispersing properties, preferably as claimed in claim 1,
b) mixing the solutions 1 and 2 prepared in step a) at a temperature in the range from 0 to 100° C., wherein the surface-modified nanoparticulate copper compounds are produced and partially form turbidity, with formation of an aqueous dispersion in the solution,
c) optionally separating the surface-modified nanoparticulate copper compounds from the aqueous dispersion obtained in step b), and
d) optionally drying the surface-modified nanoparticulate copper compounds obtained in step c).

A similar method is described in PCT/EP2009/058303.

Solution 1 described in step a) can be produced for example by dissolving a water-soluble copper salt in water or an aqueous solvent mixture. An aqueous solvent mixture can also contain, apart from water, for example water-miscible alcohols, ketones or esters such as methanol, ethanol, acetone or ethyl acetate. The water content in said solvent mixture is usually at least 50 wt. %, preferably at least 80 wt. %.

The water-soluble copper salts can for example be copper-II halides, acetates, sulfates or nitrates. Preferred copper salts are copper chloride, copper acetate, copper sulfate and copper nitrate. These salts dissolve in water with formation of copper ions, which have a double positive charge and are attached to six water molecules [Cu(H₂O)₆²⁺].

The concentration of copper ions in solution 1 is as a rule in the range from 0.05 to 2 mol/l, preferably in the range from 0.1 to 1 mol/l.

In addition to the copper ions, solution 1 can also contain other metal ions (M^{k+}), which optionally are precipitated in step b) together with the copper ions, finely divided to amorphous, but generally forming turbidity. These can for example be ions of alkaline-earth or transition metals, preferably magnesium, calcium, chromium, cobalt, nickel, zinc or silver ions, especially preferably zinc or silver ions. The additional metal ions are present in a smaller number than the copper ions.

In the method according to the invention, solution 2 contains at least one anion, which forms a precipitate with copper ions. This anion is for example anions of mineral acids such as hydrochloric acid, sulfuric acid, phosphoric acid, carbonic acid, boric acid, sulfurous acid, etc. or anions of organic acids such as oxalic acid, benzoic acid, maleic acid, etc. and polyborates such as B₄O₇²⁻. In addition, solution 2 can naturally also contain hydroxide ions additionally.

In another embodiment of the invention, the anion that forms a precipitate with copper ions may only be formed from a precursor compound in the course of the reaction taking place in step b). In this case the anion is present in the precursor compound in masked form and is released from it during mixing of solutions 1 and 2 and/or as a result of temperature change. The precursor compound can be present either in solution 1 or in solution 2 or in both solutions. As an example of said precursor compound, we may mention dimethyl carbonate, from which carbonate ions are released in the alkaline environment (cf. M. Faatz et al., Adv. Mater. 2004, Vol. 16, pages 996 to 1000).

The present invention further envisages that the claimed formulation contains the copper compound together with at least one zinc salt, preferably in sparingly soluble form, and in particular selected from the group zinc hydroxide, zinc carbonate, zinc chloride, zinc cyanide, zinc fluoride, zinc phosphate, zinc diphosphate, zinc oxide and zinc sulfate.

It has already been pointed out repeatedly that the formulation according to the invention is characterized by markedly increased penetration behavior, significantly decreased wash-out from the material treated therewith, as well as pronounced stability of the dispersion from which it is formed. For this reason it is also to be regarded as according to the invention that the physiologically active and preferably inorganic compound is present in particle form. The average particle size of the formulation should preferably be in a range from 1 nm to 10 μm, more preferably between 10 and 1000 nm and especially preferably between 50 and 500 nm. Alternatively or additionally, at least 2 wt. % of the physiologically active and preferred inorganic compounds should have a diameter of >0.5 μm.

It has already been pointed out in the context of the present description that the essential inventive aspect of the new formulation is to be regarded as the selection of a particular representative from compounds with dispersing properties and combination thereof with the actual protective substance. Thus, in variant a) it is a compound with at least one branched comb-shaped polymer with polyether side groups, a sulfonated naphthalene-formaldehyde condensation product (“BNS”) or a sulfonated melamine-formaldehyde condensation product (“MSF”). s-Triazines containing sulfonic acid groups or naphthalene-formaldehyde condensation products have been described sufficiently in the prior art and such compounds have been used for many years as so-called flow promoters in cement-based systems, for example concretes. Sulfonated β-naphthalene-formaldehyde condensation products (“BNS”), which are also called sulfonated naphthalene-formaldehyde products (“MFS”), are also used for dispersing cementitious particles on the basis of electrostatic repulsion. BNS or NFS are therefore excellent aids for dispersing cement particles and thus for increasing processability. Usually these condensation products are produced by reacting aromatic sulfonic acids, for example naphthalenesulfonic acids, with formaldehyde under normal pressure and at temperatures up to 100° C. Corresponding methods of production and the resultant products are known for example from documents EP 0 214 412 A1 and DEPS 2007603, which form an integral part of the present description by reference. The properties of BNS can be varied by varying the molar ratio between the formaldehyde component and the naphthalene component in the range from 0.7 to 3.5. The ratio of the formaldehyde component to the sulfonated naphthalene component should preferably be in the range 0.8 to 3.5:1.

Sulfonated melamine-formaldehyde condensation products (“MFS”) are also used as flow promoters in the processing of inorganic binders, for example in dry mortar mixes or other cement-bound building materials. Melamine is an excellent representative of the s-triazine group and gave the entire MFS group its name. Examples of melamine-formaldehyde sulfites are representative of the product range Melment of BASF Construction Polymers GmbH. The state of the art with respect to the MFS representatives and use thereof is just as extensive as with the BNS technology. In this connection, reference may be made to the documents DE 106 09 614 A1, DE 44 11 797 A1, EP 059 353 A1 and DE 195 38 821 A1, which with respect to the contents of their disclosure form an integral part of the present description by reference.

According to the invention, the component with dispersant action a) is a polycarboxylate ether a₁), a polycarboxylate ester a₂), an uncharged copolymer a₃) or any mixtures thereof.

The merits of the individual suitable representatives are discussed in detail below:

Polyether-containing copolymers according to copolymer a₁) are basically the best known and for example are also described in WO 2006/133933 A2. These copolymers consist of 2 monomer units, wherein the first monomer component is an olefinically unsaturated monocarboxylic acid comonomer or an ester, or a salt thereof and/or an olefinically unsaturated sulfonic acid comonomer, or a salt thereof. The second monomer component is a representative of comonomers of the following general formula (I):

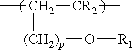

in which R₁ stands for

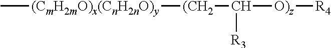

and R₂ stands for H or an aliphatic hydrocarbon residue with 1 to 5 carbon atoms; R₃=unsubstituted or substituted aryl residue and preferably phenyl, and R₄═H or an aliphatic hydrocarbon residue with 1 to 20 carbon atoms, a cycloaliphatic hydrocarbon residue with 5 to 8 carbon atoms, a substituted aryl residue with 6 to 14 carbon atoms or a member of the series

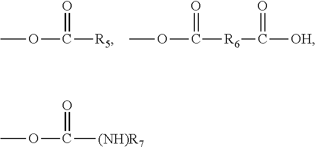

wherein R₅ and R₇ in each case stand for an alkyl, aryl, aralkyl, or alkaryl residue and R₆ stands for an alkylidene, arylidene, aralkylidene or alkarylidene residue, and
p=0, 1, 2, 3 or 4
m, n denote, independently of one another, 2, 3, 4 or 5,
   x and y denote, independently of one another, an integer ≦350 and
   z=0 to 200.

In this connection, it should be pointed out that firstly, in the copolymer a₁), the comonomer units, which represent the components 1) and 2), in each case have no intramolecular differences, and/or secondly the copolymer a₁) is a polymer mixture of components 1) and 2), wherein in this case the comonomer units have intramolecular differences with respect to the residues R₁ and/or R₂ and/or R₃ and/or R₄ and/or R₅ and/or R₆ and/or R₇ and/or m and/or n and/or x and/or y and/or z and wherein the differences mentioned relate in particular to the composition and length of the side chains.

With respect to the copolymers, the disclosure of WO 2006/133933 A2 forms an integral part of the present invention.

The present invention preferably relates to a formulation in which the copolymer a₁) contains the comonomer component 1) in proportions from 30 to 99 mol. % and the comonomer component 2) in proportions from 70 to 1 mol. %.

A copolymer of type a₁), which contains the comonomer component 1) in proportions from 40 to 90 mol. % and the comonomer component 2) in proportions from 60 to 10 mol. %, is also to be considered as preferred.

The comonomer component 1) can preferably be an acrylic acid or a salt thereof and the comonomer component 2) with p=0 or 1 can be a vinyl or allyl group and contain a polyether as residue R₁. It can moreover be regarded as advantageous if the comonomer component 1 is obtained from the group acrylic acid, methacrylic acid, crotonic acid, isocrotonic acid, allylsulfonic acid, phenylsulfonic acid and suitable salts thereof, and alkyl or hydroxyalkyl esters thereof.

Furthermore, the present invention envisages that the copolymer a₁) has additional structural units in copolymerized form. In this case the additional structural units can be styrenes, acrylamides and/or hydrophobic compounds, wherein ester structural units, polypropylene oxide and polypropylene oxide/polyethylene oxide units are especially preferred. The claimed formulation is certainly not restricted to defined proportions of the aforesaid additional structural units in the copolymer a₁); nevertheless, it is advantageous according to the invention if the copolymer a₁) contains the additional structural units in proportions up to 5 mol. %, preferably from 0.05 to 3.0 mol. % and in particular from 0.1 to 1.0 mol. %.

Regarding the suitable representatives according to formula (I), it should be noted that particular advantages are associated with an alternative in which these stand for an ether containing allyl or vinyl groups.

The polycarboxylate ester a₂) can be, according to the invention, a polymer that can be produced by polymerization of a monomer mixture (I), containing as main component a representative of the monomer-type carboxylic acid. This monomer mixture (I) should contain an (alkoxy)polyalkyleneglycol mono(meth)acrylate monomer (a) of general formula (II)

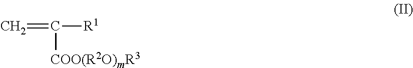

in which R¹ stands for a hydrogen atom or a CH₃ group, R²O for a representative or a mixture of at least two oxyalkylene groups with 2 to 4 carbon atoms, R³ for a hydrogen atom or an alkyl group with 1 to 5 carbon atoms and m stands for a number between 1 and 250 and represents the average number of moles of the added oxyalkylene group,
additionally as monomer (b) a (meth)acrylic acid of general formula (III),

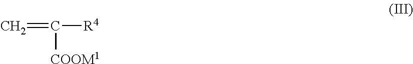

in which R⁴ stands for a hydrogen atom or a CH₃ group and M¹ for a hydrogen atom, a monovalent metal atom, a divalent metal atom, an ammonium group or an organic amine group, and optionally a monomer (c), which is copolymerizable with monomers (a) and (b).

According to the invention, monomer (a) can be contained in monomer mixture (1) in an amount from 5 to 98 wt. %, monomer (b) in an amount from 2 to 95 wt. % and monomer (c) in an amount of up to 50 wt. %, wherein in each case the amounts stated for the monomers (a), (b) and (c) add up to 100 wt. %.

Preferred representatives in the context of the present invention of the monomer (a) can be: hydroxyethyl(meth)acrylate, hydroxypropyl(meth)acrylate, polyethylene-glycol-mono(meth)acrylate, polypropylene-glycol-mono(meth)acrylate, polybutylene-glycol-mono(meth)acrylate, polyethylene-glycol-polypropylene-glycol-mono(meth)acrylate, polyethylene-glycol-polybutylene-glycol-mono(meth)acrylate, polypropylene-glycol-polybutylene-glycol-mono(meth)acrylate, polyethylene-glycol-polypropylene-glycol-polybutylene-glycol-mono(meth)acrylate, methoxy-polyethylene-glycol-mono(meth)acrylate, methoxy-polypropylene-glycol-mono(meth)acrylate, methoxy-polybutylene-glycol-mono(meth)acrylate, methoxy-polyethylene-glycol-polypropylene-glycol-mono(meth)acrylate, methoxy-polyethylene-glycol-polybutylene-glycol-mono(meth)acrylate, methoxy-polypropylene-glycol-polybutylene-glycol mono(meth)acrylate, methoxy-polyethylene-glycol-polypropylene-glycol-polybutylene-glycol-mono(meth)acrylate, ethoxy-polyethylene-glycol-mono(meth)acrylate, ethoxy-polypropylene-glycol-mono(meth)acrylate, ethoxy-polybutylene-glycol-mono(meth)acrylate, ethoxy-polyethylene-glycol-polypropylene-glycol-mono(meth)acrylate, ethoxy-polyethylene-glycol-polybutylene-glycol-mono(meth)acrylate, ethoxy-polypropylene-glycol-polybutylene-glycol-mono(meth)acrylate, ethoxy-polyethylene-glycol-polypropylene-glycol-polybutylene-glycol-mono(meth)acrylate or mixtures thereof.

Monomer (b) can be a member of the group acrylic acid, methacrylic acid, monovalent metal salts, divalent metal salts, ammonium salts and organic amine salts thereof or mixtures thereof.

Esters of an aliphatic alcohol with 1 to 20 carbon atoms with an unsaturated carboxylic acid may come into consideration as representatives of monomer (c). The carboxylic acids are in this case preferably selected from the unsaturated carboxylic acids, such as maleic acid, fumaric acid, citraconic acid, (meth)acrylic acid. However, monovalent metal salts, divalent metal salts, ammonium salts or organic amine salts thereof may also be considered. Monomers (c) can, however, also be monoesters or diesters of unsaturated carboxylic acids, such as maleic acid, fumaric acid or citraconic acid, with aliphatic C₁ to C₂₀ alcohols, C₂ to C₄ glycols or also with (alkoxy)polyalkylene glycol.

With regard to component a₂), the present invention also envisages that it is a copolymer, based on at least one of the monomers present:
A) an ethylenically unsaturated monomer, comprising a hydrolyzable residue, wherein this hydrolyzable monomer has an active binding site for at least one component of the final composition having the formulation;
B) an ethylenically unsaturated monomer with at least one C₂-C₄-oxyalkylene side group with a chain length of 1 to 30 units;
C) an ethylenically unsaturated monomer with at least one C₂-C₄-oxyalkylene side group with a chain length of 31 to 350 units.

Components B) and C) can be represented simultaneously in copolymer a₂).

The ethylenically unsaturated monomer of component A) can comprise, according to the invention, at least one anhydride or imine and/or at least one maleic anhydride or maleimide. The ethylenically unsaturated monomer of component A) can, however, also comprise an acrylic acid ester with an ester functionality, which contains the hydrolyzable residue. In this case it is recommended for the ester functionality to be at least one hydroxypropyl or hydroxyethyl residue. Furthermore, it is to be regarded as preferable if the copolymer a₂) in component A) has more than one ethylenically unsaturated monomer with a hydrolyzable residue. In this case the ethylenically unsaturated monomer of component A) can have, as residue, at least more than one representative of the ethylenically unsaturated monomers, at least one representative of a hydrolyzable residue or a mixture of both. It can also be advantageous if the hydrolyzable residue in the last-mentioned cases has at least one C₂-C₂₀ alcohol functionality. The hydrolyzable residue can represent a C₁-C₂₀-alkyl ester, a C₁-C₂₀-aminoalkyl ester, an amide or mixtures thereof.

Also with respect to components B) and C), it is envisaged according to the invention that these can have—in each case independently of one another—at least one ethylenically unsaturated monomer in the form of a C₂-C₈-alkyl ether group. The ethylenically unsaturated monomer should preferably have a phenyl, allyl or (methyl)allyl ether residue, or should be derived from an unsaturated C₂-C₈ alcohol, which is preferably at least one representative from the group phenyl alcohol, (meth)allyl alcohol, isoprenol or methylbutenol.

The present invention further comprises that the ethylenically unsaturated monomer side groups of components B) or C) have at least one C₄-oxyalkylene unit and/or that at least one ethylenically unsaturated monomer of components B) or C) has a C₂-C₈-carboxylic acid ester, which is in particular hydrolyzable.

It is further envisaged that the oxyalkylene side groups in components B) and/or C) have at least one ethylene oxide, propylene oxide, polyethylene oxide, polypropylene oxide or mixtures thereof.

The copolymer a₂) in component C) can also have at least one nonionic and/or a non-hydrolyzable monomer residue or mixtures thereof.

Also with respect to the uncharged copolymer a₃) as variant of component a), the present invention envisages several preferred alternatives.

Thus, the uncharged copolymer a₃), which can also be designated as nonionic copolymer, can be a representative of general formula (IV)

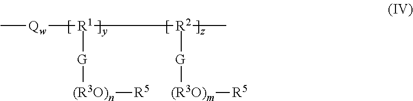

in which Q stands for an ethylenically unsaturated monomer with at least one hydrolyzable residue, G denotes O, C(O)—O or O—(CH₂)ₚ—O with p=2 to 8, wherein mixtures of the variants of 0 in one polymer are possible; R¹ and R² denote, independently of one another, at least one C₂-C₈-alkyl; R³ comprises (CH₂)_{c}, wherein c is an integer between 2 and 5 and wherein mixtures of the representatives of R³ in the same polymer molecule are possible; R⁵ denotes at least one representative selected from the group H, a linear or branched, saturated or unsaturated C₁-C₂₀ aliphatic hydrocarbon residue, a C₅-C₈ cycloaliphatic hydrocarbon residue or a substituted or unsubstituted C₆-C₁₄ aryl residue; m=1 to 30, n=31 to 350, w=1 to 40, y=0 to 1 and z=0 to 1, wherein the sum (y+z)>0.

The uncharged or nonionic copolymer a₃) can, however, also denote a representative of general formula (V).

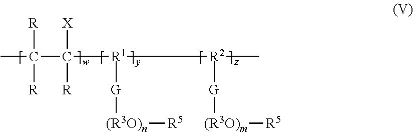

in which X stands for a hydrolyzable residue and R stands for H or CH₃; G, p, R¹, R², R³, R⁵, m, n, w, y, z and (y+z) have the meanings stated under formula (IV). The aforementioned hydrolyzed residue can preferably be at least one representative selected from the group alkyl ester, hydroxyalkyl ester, aminohydroxyalkyl ester or amide.

However, it is also possible in the context of the present invention for the uncharged or nonionic copolymer a₃) to be at least one representative of general formula (VI)

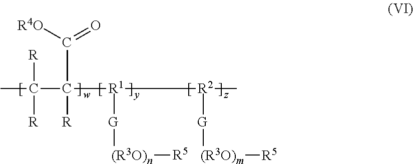

in which R⁴ denotes at least one C₁-C₂₀ alkyl or C₂-C₂₀ hydroxyalkyl residue and the residues G, p, R, R¹, R², R³, c, R⁴, R⁵ and m, n, w, y, z and (y+z) have the meanings given under formulas (IV) and (V).

Preferably p=4 and R⁴═C₂H₄OH or C₃H₆OH; each of the residues R⁵ stands for H, m=5-30, n=31-250, w=1.5-30, y=0 to 1, z=0 to 1 and (y+z)>0. The molar ratio of w to the sum (y+z) is 1:1 to 20:1 and is preferably 2:1 to 12:1.

It is to be regarded as preferable for the copolymer a₃) to be a nonionic polyether-polyester copolymer.

Also with respect to component b), i.e. the polycondensation product, the present invention envisages numerous suitable variants. Thus, the structural units (I), (II) and (III) of component B) can preferably be represented by the following formulas:

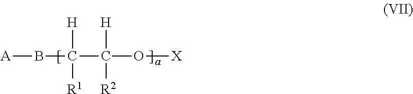

with
A identical or different and represented by a substituted or unsubstituted aromatic or heteroaromatic compound with 5 to 10 carbon atoms
with
B identical or different and represented by N, NH or O
with
n=2, if B═N, and n=1, if B═NH or O
with
R¹ and R², independently of one another, identical or different and represented by a linear or branched C₁- to C₁₀-alkyl residue, C₅- to C₈-cycloalkyl residue, aryl residue, heteroaryl residue or H
with
a identical or different and represented by an integer from 1 to 300
with
X identical or different and represented by a linear or branched C₁- to C₁₀-alkyl residue, C₅- to C₈-cycloalkyl residue, aryl residue, heteroaryl residue or H

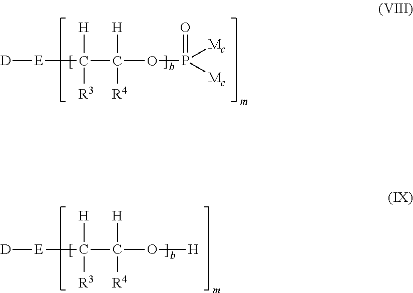

for (VIII) and (IX) in each case:
with
D identical or different and represented by a substituted or unsubstituted heteroaromatic compound with 5 to 10 carbon atoms
   with
   E identical or different and represented by N, NH or O
   with
   m=2, if E=N, and m=1, if E=NH or O
   with
   R³ and R⁴, independently of one another, identical or different and represented by a linear or branched C₁- to C₁₀-alkyl residue, C₅- to C₈-cycloalkyl residue, aryl residue, heteroaryl residue or H
   with b identical or different and represented by an integer from 0 to 300
   with
   M independently of one another an alkali, alkaline-earth, ammonium or an organic ammonium acid ion and/or H,
   with
   c=1 or in the case of an alkali ion=½

It is also envisaged according to the invention that component b) contains another structural unit (X), which is represented by the following formula

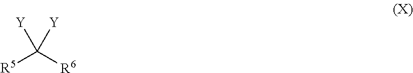

with

Y, independently of one another, identical or different and represented by (VII), (VIII), (IX) or further constituents of polycondensation product b)

with

R⁵ identical or different and represented by H, CH₃, COOH or a substituted or unsubstituted aromatic or heteroaromatic compound with 5 to 10 carbon atoms

with

R⁶ identical or different and represented by H, CH₃, COOH or a substituted or unsubstituted aromatic or heteroaromatic compound with 5 to 10 carbon atoms.

The residues R⁵ and R⁶ in this structural unit (X) of component b) can, independently of one another, be identical or different and can be represented by HCOOH and/or methyl.

The molar ratio of the structural units [(VII)+(VIII)+(VIIII)]:(X) in component b) should be 1:0.8 to 3, and alternatively or in addition to this variant, the molar ratio of the structural units (VII):[(VIII)+(VIIII)] in component b) should be 1:15 to 15:1 and preferably 1:10 to 10:1.

It is also envisaged that the molar ratio of the structural units (VIII):(VIIII) of component b) is 1:0.005 to 1:10.

On the whole it has proved advantageous if the polycondensation product b) is in an aqueous solution, which contains 2 to 90 wt. % water and 98 to 10 wt % of dissolved dry matter.

Component b), thus at least one representative of the polycondensation product, is regarded according to the invention as preferred compound with dispersing properties.

The present invention equally comprises the possibility that component a) is used in proportions from 5 to 95 wt. %, preferably from 10 to 60 wt. % and especially preferably from 15 to 40 wt. %, in each case relative to the total formulation. Component b) should be contained in the formulation according to the invention in proportions from 5 to 100 wt. %, preferably from 10 to 60 wt. % and especially preferably from 15 to 40 wt. %, in each case again relative to the total formulation.

It is also envisaged that the claimed formulation contains, in addition to components a) and b), at least one antifoaming agent as component c) and/or a component d) with surface-active action, wherein the components c) and d) are structurally different one another. In this connection, a suitable antifoaming component c) is preferably at least one representative of the group mineral oil, vegetable oil, silicone oil, silicone-containing emulsions, fatty acid, fatty acid ester, organically modified polysiloxane, borate ester, alkoxylate, polyoxyalkylene copolymer, ethylene oxide (EO)-propylene oxide (PO) block polymer, acetylenic diol with antifoaming properties, phosphoric acid ester of formula P(O)(O—R₈)₃₋ₓ(O—R₉)ₓ in which P=phosphorus, O=oxygen and R₈ and R₉, independently of one another, denote a C₂₋₂₀ alkyl or an aryl group and x=0, 1 or 2. The antifoaming component c) can in particular be at least one representative of the group trialkyl phosphate, polyoxypropylene copolymer and/or glycerin alcohol acetate, wherein triiso-butylphosphate is particularly suitable as antifoaming component c). However, a mixture of a trialkylphosphate and a polyoxypropylene copolymer can also be contained as additional component c) in the formulation.

Particularly suitable representatives of component d) with surface-active action are compounds selected from the group ethylene oxide/propylene oxide (EO/PO) block copolymer, styrene/maleic acid copolymer, fatty acid alcohol alkoxylate, alcohol ethoxylate R₁₀-(EO)—H with R₁₀=an aliphatic hydrocarbon group with 1 to 25 carbon atoms, acetylenic diol, monoalkylpolyalkylene, ethoxylated nonylphenol, alkyl sulfate, alkylether sulfate, alkylether sulfonate or alkylether carboxylate. Component d) can, however, also comprise an alcohol with a poiyalkylene group, wherein the polyalkylene group has a carbon chain length from 2 to 20 carbon atoms and preferably from 3 to 12 carbon atoms.

It is generally regarded as advantageous if the antifoaming component c) is in free form, or else bound to the dispersing component a), wherein mixtures of these two forms can of course also be contained in the formulation.

Regarding the antifoaming component c) and the surface-active component d), in each case amounts from 0.01 to 10 wt. %, relative to the weight of the total formulation, have proved to be advantageous, wherein for the two components naturally any proportions can be selected independently of one another from the stated range. The preferred amounts used for both components c) and d), independently of one another, are amounts between 0.01 and 5 wt. %, once again relative to the weight of the total formulation, and again in this case for the two aforesaid components, the respective amounts can be selected independently of one another and can be combined with one another in any way.

In the context of the present invention, in addition to the essential components a) and b) and the optionally additionally contained components c) and/or d), the claimed formulation can contain, as further component e), at least one compound, selected from the group of polymers with low charge or the polyphenyl alcohols. This further additional component can be used in amounts from 1 to 50 wt. %, preferably from 5 to 40 wt. % and especially preferably in amounts from 10 to 30 wt. %, in each case relative to the total weight of the formulation. From the group of polymers with low charge, those representatives that are branched and preferably contain a polyether and/or a polyester as side chain, are particularly suitable. The low-charge polymer according to the invention can in particular be a polycarboxylate ether and/or a polycarboxylate ester, preferably with EO side chains and/or with a proportion of carboxylate up to 83 mol. %, and preferably up to 75 mol. %.

In the context of the present invention, it is also to be regarded as advantageous if the low-charge polymer e) is constructed from at least one monomer selected from the group polyether monoacrylate, polyether monomethacrylate, polyether monoallyl ether, polyether monomaleate, monovinylated polyether or mixtures thereof. Consideration may be given in particular to polyether representatives that are an alkylene oxide polymer with a molecular weight from 500 to 10 000, preferably from 750 to 7500 and in particular from 1000 to 5000. From the group of alkylene oxide polymers that may come into consideration for this, the present invention envisages in particular ethylene oxide, propylene oxide, butylene oxide or mixtures thereof.

Monomers selected from the group polypropylene-glycol acrylates, polypropylene-glycol methacrylates, polyethylene-glycol acrylates, polyethylene-glycol methacrylates, polypropylene-glycol-monovinyl ethers, polythylene-glycol-monovinyl ethers, alkoxy- or aryloxy-polythylene-glycol acrylates, alkoxy- or aryloxy-polythylene-glycol methacrylates, alkoxy- or aryloxy-polythylene-glycol-monovinyl ethers, acrylates, methacrylates and monovinyl ethers of an oxyethylene and oxypropylene block or randomized copolymer, polypropylene-glycol-allyl ethers, polyethylene-glycol-allyl ethers, polyethylene-glycol-monomaleate polypropylene-glycol-monomaleate and any mixtures thereof, are preferred budding blocks for the low-charge polymer e).

This bears in particular a carboxylic acid group, which was preferably selected from the group acrylic acid, methacrylic acid, maleic acid, fumaric acid, itaconic acid or anhydrides thereof. The low-charge polymer e) may also bear a sulfonic acid group selected from the group 2-acrylamide-2-methylpropanesulfonic acid (AMPS), vinylsulfonic acid, allyl ethersulfonic acid, 2-sulfoethylmethacrylic acid, styrene-sulfonic acid, methallylsulfonic acid, sodium, potassium and ammonium salts thereof and any mixtures thereof, and in particular AMPS and vinylsulfonic acid.

Finally, the neutral polymer e) can be constructed from neutral monomer building blocks, which are selected in particular from the group acrylic acid alkyl esters and methacrylic acid alkyl esters and hydroxyalkyl esters thereof with up to 5 carbon atoms, in particular hydroxyethyl acrylate and hydroxypropyl acrylate or hydroxyethyl methacrylate and hydroxypropyl methyacrylate, and vinyl acetate, N-vinylpyrrolidone, N-vinylcaprolactam, styrene and methylstyrene, and mixtures thereof.

All the aforesaid compounds with dispersing properties should be contained in the formulation according to the invention in an amount from 1.0 to 40 wt. %, preferably from 3.0 to 30 wt. % and especially preferably from 5 to 20 wt. %, in each case relative to the solids content of the dispersing component.

The present invention also envisages that in addition to the essential constituents according to the invention, namely the protective substance and the compound with dispersing properties, the formulation can further contain at least one other substance, preferably as a processing aid, and selected from the group extender, emulsifier, binder, dye, biocide, stabilizer, antisettling agent, marking agent, separating agent etc.

The formulations according to the invention are usually prepared by mixing the protective substance with extenders, i.e. liquid solvents and/or solid carriers as concentrates. These concentrates can naturally be diluted for use by mixing with at least one suitable liquid medium, generally water, and can thus be adapted to the particular application. When using water as extender, for example organic solvents can also be used as auxiliary solvents. Examples of possible solid carriers are natural and synthetic powdered stone. Suitable emulsifiers are for example nonionogenic and anionic emulsifiers, such as ethoxylated fatty acid esters, fatty acid alcohols, fatty alcohol ethers or also alkyl sulfates or alkyl sulfonates.

Biocides are preferably to be understood as fungicides and insecticides; however, preservatives and representatives of substances that can repel or kill harmful organisms are also possible.

Colorants that can be present are inorganic pigments, for example iron oxide, titanium dioxide and organic dyes, for example alizarin, azo and metal phthalocyanine dyes. These pigments can, as inorganic compounds, also be physiologically active and can therefore at least support the actual protective substance in its action.

The formulation can contain these further substances in a total amount of up to 25 wt. %, preferably up to 20 wt. % and especially preferably up to 10 wt. %, in each case relative to the total formulation.

The formulations covered by the present invention generally contain between 0.5 and 60 wt. % of protective substance, preferably between 1 and 35 wt. %. The formulations used for protecting cellulose-containing materials contain the protective substances in an amount between 0.05 and 35 wt. % as concentrate or dilutions obtainable therefrom, in their respective form ready for application.

Preferred compositions of the formulations according to the invention contain:
0.5-60 wt. % of a metal compound and in particular copper compound
0.2-40 wt. % of dispersants
5-98 wt. % of extenders
0.1-15 wt. % of biocides
0-10 wt % of emulsifiers/stabilizers
0-5 wt. % of dyes/pigments

As well as the formulation, its composition and proportions of components, the present invention also claims the use of said formulations as protective agent for cellulose-containing materials and in particular as plant protection agent and/or wood preservative, wherein wood-containing materials such as for example wood-containing building materials and preferably solid wood and/or wood materials are especially suitable. The materials to be treated can be untreated and/or unprocessed (rough lumber), but can also be in processed form.

Depending on the material to be treated, for use as wood preservative the formulation should preferably be in the form of a suspension, suitable in particular for pressure treatment for industrial impregnation processes, for example vacuum, double-vacuum or pressure processes, or for injection. Other known wood treatment techniques, for example spraying or dipping, are also possible applications.

The following examples illustrate the advantages of the invention.

### EXAMPLES

### 1) Suggested Recipes for Formulations According to the Invention

The following two examples 1 and 2 represent precursors of the final wood preservatives, with which the suitability of the formulation for special profiles of requirements (penetration, wash-out) can be illustrated:

### Example 1

### Concentrate

40.0 wt. % basic copper carbonate (protective substance)
16.0 wt. % polycarboxylate ether (Melment® from BASF Construction Polymers GmbH; dispersant)
44.0 wt. % water

This formulation was prepared by wet grinding in a stirrer mill. The average particle size in the total formulation, measured using laser diffraction, was approx. 0.15 μm, after a grinding time of 90 minutes. The concentrates of this suspension and the aqueous dilutions thereof (1:99; 1:49) were stable and the dilutions were used for conducting penetration tests on lumber from European pine (Pinus sylvestris). The lumber was impregnated by a vacuum-pressure process. Complete sapwood penetration was achieved.

### Example 2

### Concentrate

15.0 wt. % basic copper carbonate (protective substance)
6.2 wt. % phosphate-containing polycondensation product (dispersant)
78.8 wt. % water

This formulation was produced by wet grinding with 0.5 mm glass grinding media in a stirrer mill. The average particle size in the total formulation, measured using laser diffraction, was approx. 0.2 μm, after a grinding time of 1 h. The concentrates of this suspension and the aqueous dilutions thereof (1:99; 1:49) were stable and the dilutions were used for conducting penetration tests on lumber from European pine (Pinus sylvestris). The lumber was impregnated by a vacuum-pressure process. Complete sapwood penetration was achieved.

The next example 3 gives the test results for a wood preservative consisting of a combination of copper salt and organic co-biocide:

### Example 3

### Concentrate

40.0 wt. % basic copper carbonate (protective substance)
1.0 wt. % commercial tebuconazole (protective substance)
16.0 wt % polycarboxylate ether (Melment® from BASF Construction Polymers GmbH; dispersant)
43.0 wt. % water

This formulation was prepared by wet grinding with Al₂O₃ grinding media (average diameter: 0.4 mm) in a stirrer mill. The average particle size in the total formulation, measured using laser diffraction, was approx. 0.16 μm, after a grinding time of 60 minutes. The concentrates of this suspension and the aqueous dilutions thereof (1:99; 1:49) were stable and the dilutions were used for conducting penetration tests on lumber from European pine (Pinus sylvestris). The lumber was impregnated by a vacuum-pressure process. Complete sapwood penetration of the two protective substances was achieved.

### 2) Dilutions as Formulations According to the Invention

### Example 4

Suspensions diluted with water, ready for use, examples 1 to 3 containing 0.35 or 0.5 wt % of protective substance (copper carbonate), were used for testing wash-out behavior of the copper by the standard method according to EN 84. The Cu wash-out rates obtained were in the region of on average 6% Cu and therefore were significantly lower than those of the Cu-alkanolamine-containing products usually employed at present (dissolved complexed Cu compounds), which are in the range between 8 and 12%. These tests confirmed that the stabilized particles obtained have a beneficial effect on the wash-out behavior of the copper.

### 3) Use in Autoclave Impregnation of Various Types of Wood

Suspensions diluted with water according to examples 1 to 3 were used for carrying out impregnation tests using known autoclave techniques on solid wood of pine, spruce and fir, achieving very good penetration results. The Cu penetration in the impregnated wood was always at least as good or even better than with the Cu-alkanolamine-containing products usually employed at present. This is a very good indication for use as wood preservative.

1-91. (canceled)

92. A formulation comprising:
at least one protective substance that is active with respect to cellulose-containing materials; and
at least one compound with dispersing properties; wherein the compound with dispersing properties comprises at least one member selected from the group consisting of
a) compound at least containing a branched comb-shaped polymer with polyether side chains, naphthalene-sulfonate-formaldehyde-condensate and melamine-sulfonate-formaldehyde-condensate,
and
b) a polycondensation product containing
(I) at least one structural unit having an aromatic or heteroaromatic and a polyether side chain; and
(II) at least one phosphatized structural unit having an aromatic or heteroaromatic, wherein the phosphatised strucral unit has an OP(OH)₂ group; and
(III) at least one structural unit having an aromatic or
heteroaromatic,
wherein structural unit (II) and structural unit (III) differ exclusively in that the OP(OH)₂ group of structural unit (II) is replaced with H in structural unit (III) and structural unit (III) is different from structural unit (I).

93. The formulation as claimed in claim 92, wherein the protective substance that is active with respect to cellulose-containing materials is at least one physiologically active and preferably inorganic compound.

94. The formulation as claimed in claim 92, wherein the physiologically active compound is at least one copper compound.

95. The formulation as claimed in claim 92, wherein the copper compound is at least one representative of formula
[Cu²⁺]₁₋ₓ[M^{k+}]ₓ[Xⁿ⁻]ₐ[Y^{m-}]_{b}.eH₂O,
wherein
M^{k+} is a metal ion of valence k,
0≦x≦0.5,
Xⁿ⁻ is at least one inorganic anion with average valence n, which form a solid with copper ions in water,
Y^{m-} is at least one organic anion with the valence m,
a≧0, b≧0 and the ratio of a, h and x dependent on the valences k, n and m according to the formula a·n+b·m=2·(1−x)+x·k, and
e≧0.

96. The formulation as claimed in claim 95, wherein it is a copper compound, for which x is 0.

97. The formulation as claimed in claim 95, wherein it is a copper compound, for which X is at least one member selected from the group consisting of hydroxide, carbonate, phosphate, hydrogen phosphate, oxalate, borate and tetraborate ion.

98. The formulation as claimed in claim 97, wherein the copper compound is at least one sparingly soluble copper salt.

99. The formulation as claimed in claim 97, wherein the copper compound is at least one member selected from the group copper hydroxide, copper borate, basic copper borate, copper carbonate, basic copper carbonate, tribasic copper sulfate, copper oxychloride, alkaline copper nitrate, copper-iron(III) cyanide, copper-iron(III) cyanate, copper fluorosilicate, copper thiocyanate, copper diphosphate, copper boride, copper phosphate and copper oxide.

100. The formulation as claimed in claim 95, wherein the physiologically active compound is at least one copper compound that has been surface modified.

101. The formulation as claimed in claim 100, comprising a surface-modified copper compound, which was produced by a method comprising the steps of:
a) preparing an aqueous solution containing copper ions (solution 1) and an aqueous solution containing at least one anion that forms a turbid matter with copper ions (solution 2), wherein at least one of the two solutions 1 and 2 contains at least one processing aid with dispersing properties, and
b) mixing the solutions 1 and 2 prepared in step a) at a temperature in the range from 0 to 100° C., wherein the surface-modified nanoparticulate copper compounds are generated and partially form turbidity, with formation of an aqueous dispersion in the solution.

102. The formulation as claimed in claim 94, wherein it contains the copper compound together with at least one zinc salt.

103. The formulation according to claim 102, wherein the zinc salt is selected from the group consisting of zinc hydroxide, zinc carbonate, zinc chloride, zinc cyanide, zinc fluoride, zinc phosphate, zinc diphosphate, zinc oxide and zinc sulphate.

104. The formulation as claimed in claim 94, wherein the physiologically active and preferably inorganic compound is in particle form.

105. The formulation as claimed in claim 103, wherein the average particle size is in a range from 1 nm to 10 micrometer.

106. The formulation as claimed in claim 92, wherein at least 2 wt. % of the physiologically active and preferably inorganic compound has a diameter of >0.5 micrometer.

107. The formulation as claimed in claim 92, wherein the component with dispersant action a) is a polycarboxylate ether a₁), a polycarboxylate ester a₂), an uncharged copolymer a₃) or mixtures thereof.

108. The formulation as claimed in claim 92, wherein the component a) is a copolymer a₁), consisting of
1) an olefinically unsaturated monocarboxylic acid comonomer, an ester of an olefinically unsaturated monocarboxylic acid comonomer, a salt of an olefinically unsaturated monocarboxylic acid comonomer, an olefinically unsaturated sulfonic acid comonomer or a salt of an olefincally unsaturated sulfonic acid comonomerf, and
2) at least one comonomer of formula (I) 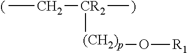
in which R₁ is 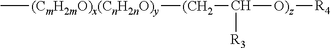
and R₂ stands for H or an aliphatic hydrocarbon residue with 1 to 5 carbon atoms; R₃ is an unsubstituted or substituted aryl residue and preferably phenyl, and R₄ is H or an aliphatic hydrocarbon residue with 1 to 20 carbon atoms, a cycloaliphatic hydrocarbon residue with 5 to 8 carbon atoms, a substituted aryl residue with 6 to 14 carbon atoms or 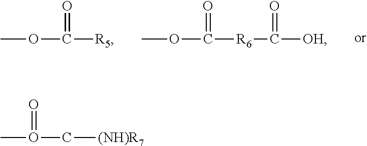
wherein R₅ and R₇ are independently an alkyl, aryl, aralkyl, or alkaryl residue; and
R₆ stands for an alkylidene, arylidene, aralkylidene or alkarylidene residue;
and
p is 0, 1, 2, 3 or 4;
m and n are independently of one another 2, 3, 4 or 5;
x and y are independently of one another an integer ≦350; and
z is from 0 to 200,
wherein (I) in the copolymer a₁) the comonomer units, which represent the components 1) and 2), in each case have no intramolecular differences, and/or (II) the copolymer a₁) represents a polymer mixture of the components 1) and 2), wherein in this case the comonomer units have intramolecular differences with respect to the residues R₁ and/or R₂ and/or R₃ and/or R₄ and/or R₅ and/or R₆ and/or R₇ and/or m and/or n and/or x and/or y and/or z and wherein the aforementioned differences relate in particular to the composition and length of the side chains.

109. The formulation as claimed in claim 108, wherein the copolymer a₁) contains the comonomer component 1) in proportions from 30 to 99 mol. % and the comonomer component 2) in proportions from 70 to 1 mol. %.

110. The formulation as claimed in claim 108, wherein the copolymer a₁) contains the comonomer component 1) in proportions from 40 to 90 mole % and the comonomer component 2) in proportions from 60 to 10 mol. %.

111. The formulation as claimed in claim 108, wherein the comonomer component 1) is for an acrylic acid or a salt thereof, and the comonomer component 2) wherein p is 0 or 1 contains a vinyl or allyl group and contains a polyether as R₁.

112. The formulation as claimed in claim 108, wherein the comonomer component 1) is derived from a member of the group consisting of acrylic acid, methacrylic acid, crotonic acid, isocrotonic acid, allylsulfonic acid and vinylsulfonic acid, salts thereof, and alkyl or hydroxyalkyl esters thereof.

113. The formulation as claimed in claim 108, wherein the copolymer a₁) has additional structural units in copolymerized form.

114. The formulation as claimed in claim 113, wherein the additional structural units are selected from the group consisting of a styrene, an acrylamide and a hydrophobic compound.

115. The formulation as claimed in claim 113, wherein the copolymer a₁) contains the additional structural units in proportions up to 5 mol %.

116. The formulation as claimed in claim 107, wherein formula (I) is a polyether containing allyl or vinyl group.

117. The formulation as claimed in claim 92, wherein the polycarboxylate ester a₂) is a polymer, produced by polymerization of a monomer mixture (I), containing a representative of the carboxylic acid type of monomer as main component.

118. The formulation as claimed in claim 117, wherein the monomer mixture (I) contains an (alkoxy)polyalkylene glycol mono(meth)acrylic acid ester monomer (a) of general formula (II) 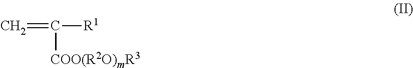
wherein R¹ is a hydrogen atom or a CH₃ group, R²O for a representative or a mixture of at least two oxyalkylene groups with 2 to 4 carbon atoms, R³ for a hydrogen atom or an alkyl group with 1 to 5 carbon atoms and m stands for a number between 1 and 250 and represents the average number of moles of the added oxyalkylene group; and
as monomer (b), a (meth)acrylic acid of formula (III), 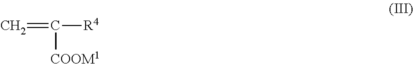
wherein R⁴ is for a hydrogen atom or a CH₃ group and M¹ for a hydrogen atom, a monovalent metal atom, a divalent metal atom, an ammonium group or an organic amine group, and optionally a monomer (c), which is copolymerizable with monomers (a) and (h).

119. The formulation as claimed in claim 118, wherein monomer (a) is contained in the monomer mixture (I) in an amount from 5 to 98 wt %, monomer (b) in an amount from 2 to 95 wt. % and wherein monomer (c) is present in an amount of up to 50 wt. %, wherein the respective amounts of monomers (a), (b) and (c) add up to 100 wt. %.

120. The formulation as claimed in claim 117, wherein monomer (a) is at least one member selected from the group consisting of a hydroxy-ethyl(meth)acrylate, a hydroxy-propyl(meth)acrylate, a polyethylene-glycol-mono(meth)acrylate, a polypropylene-glycol-mono(meth)acrylate, a polybutylene-glycol-mono(meth)acrylate, a polyethylene-glycol-polypropylene-glycol-mono(meth)acrylate, a polyethylene-glycol-polybutylene-glycol-mono(meth)acrylate, a polypropylene-glycol-polybutylene-glycol-mono(meth)acrylate, a polyethylene-glycol-polypropylene-glycol-polybutylene-glycol-mono(meth)acrylate, a methoxy-polyethylene-glycol-mono(meth)acrylate, methoxy-polypropylene-glycol-mono(meth)acrylate, a methoxy-polybutylene-glycol-mono(meth)acrylate, a triethoxy-polyethylene-glycol-polypropylene-glycol-mono(meth)acrylate, a methoxy-polyethylene-glycol-polybutylene-glycol-mono(meth)acrylate, a methoxy-polypropylene-glycol-polybutylene-glycol-mono(meth)acrylate, a methoxy-polyethylene-glycol-polypropylene-glycol-polybutylene-glycol-mono(meth)acrylate, an ethoxy-polyethylene-glycol-mono(meth)acrylate, an ethoxy-polypropylene-glycol-mono(meth)acrylate, an ethoxy-polybutylene-glycol-mono(meth)acrylate, an ethoxy-polyethylene-glycol-polypropylene-glycol-mono(meth)acrylate, an ethoxy-polyethylene-glycol-polybutylene-glycol-mono(meth)acrylate, an ethoxy-polypropylene-glycol-polybutylene-glycol-mono(meth)acrylate, and an ethoxy-polyethylene-glycol-polypropylene-glycol-polybutylene-glycol-mono(meth)acrylate.

121. The formulation as claimed in claim 117, wherein monomer (b) is a member of the group acrylic acid, methacrylic acid, monovalent metal salts, divalent metal salts, ammonium salts and organic amine salts thereof and mixtures thereof.

122. The formulation as claimed in claim 119, wherein monomer (c) is at least one ester of an aliphatic alcohol with 1 to 20 carbon atoms with an unsaturated carboxylic acid.

123. The formulation as claimed in claim 122, wherein the unsaturated carboxylic acid is selected from the group consisting of maleic acid, fumaric acid, citraconic acid, and (meth)acrylic acid, or a monovalent metal salt, a divalent metal salt, an ammonium salt or an organic amine salt thereof.

124. The formulation as claimed in claim 122, wherein monomer (c) is a monoester or diester of an unsaturated dicarboxylic acid, with aliphatic C₁-C₂₀ alcohols, C₂-C₄ glycols or with (alkoxy)polyalkylene glycols.

125. The formulation as claimed in claim 105, wherein component a₂) is a copolymer, based on at least one of the following monomers:
A) an ethylenically unsaturated monomer, comprising a hydrolyzable residue, wherein this hydrolyzable monomer has an active binding site for at least one component of the final composition having the formulation;
B) an ethylenically unsaturated monomer with at least one C₂-C₄-oxyalkylene side group with a chain length of 1 to 30 units;
C) an ethylenically unsaturated monomer with at least one C₂-C₄-oxyalkylene side group with a chain length of 31 to 350 units.

126. The formulation as claimed in claim 125, wherein the components B) and C) are represented simultaneously in copolymer a₂).

127. The formulation as claimed in claim 125, wherein the ethylenically unsaturated monomer of component A) comprises at least one anhydride, an imide, a maleic anhydride or maleimide.

128. The formulation as claimed in claim 125, wherein the ethylenically unsaturated monomer of component A) comprises an acrylic acid ester with an ester functionality, which contains the hydrolyzable residue.

129. The formulation as claimed in claim 128, wherein the ester functionality is at least one hydroxypropyl or hydroxyethyl residue.

130. The formulation as claimed in claim 125, wherein the copolymer a₂) in component A) has more than one ethylenically unsaturated monomer with a hydrolyzable residue.

131. The formulation as claimed in claim 130, wherein the ethylenically unsaturated monomer of component A) has as residue at least more than one representative of the ethylenically unsaturated monomers, at least one representative of a hydrolyzable residue or a mixture of the two.

132. The formulation as claimed in claim 130, wherein the hydrolyzable residue has at least one C₂-C₂₀ alcohol functionality.

133. The formulation as claimed in claim 130, wherein the hydrolyzable residue is at least one C₁-C₂₀-alkyl ester, C₁-C₂₀-aminoalkyl ester or an amide.

134. The formulation as claimed in claim 125, wherein at least one ethylenically unsaturated monomer of component B) or C) has a C₂-C₈-alkyl ether group.

135. The formulation as claimed in claim 134, wherein the ethylenically unsaturated monomer has a vinyl, allyl or (methyl)allyl ether residue or is derived from an unsaturated C₂-C₈ alcohol.

136. The formulation as claimed in claim 135, wherein the unsaturated C₂-C₈ alcohol is at least one representative of the group vinyl alcohol, (meth)allyl alcohol, isoprenol or methylbutenol.

137. The formulation as claimed in claim 125, wherein the ethylenically unsaturated monomer side groups of component B) or C) have at least one C₄-oxyalkylene unit.

138. The formulation as claimed in claim 125, wherein at least one ethylenically unsaturated monomer of component B) or C) has a C₂-C₈-carboxylic acid ester which is hydrolyzable.

139. The formulation as claimed in claim 125, wherein the oxyalkylene side groups have at least one ethylene oxide, propylene oxide, polyethylene oxide, polypropylene oxide or mixtures thereof.

140. The formulation as claimed in claim 125, wherein the copolymer a₂) in component C) has at least one of a nonionic or a non-hydrolyzable monomer residue.

141. The formulation as claimed in claim 107, wherein the nonionic copolymer a₃) is a of formula (IV) 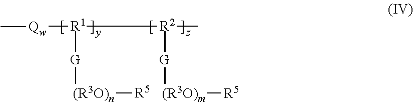
wherein Q stands for an ethylenically unsaturated monomer with at least one hydrolyzable residue;
G denotes O, C(O)—O or O—(CH₂)ₚ—O wherein p is from 2 to 8;
R¹ and R² are independently of one another C₂-C₈-alkyl; R³ comprises (CH₂)_{c}, wherein c is an integer between 2 and 5 and wherein mixtures of the representatives of R³ in the same polymer molecule are possible; R⁵ is a least one representative selected from the group H, a linear or branched, saturated or unsaturated C₁-C₂₀ aliphatic hydrocarbon residue, a C₅-C₈ cycloaliphatic hydrocarbon residue or a substituted or unsubstituted C₆-C₁₄ aryl residue; m=1 to 30, n=31 to 350, w=1 to 40, y=0 to 1 and z=0 to 1, wherein the sum (y+z)>0.

142. The formulation as claimed in claim 107, wherein the nonionic copolymer a₃) is a representative of general formula (V) 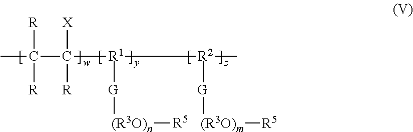
in which X stands for a hydrolyzable residue and R stands for H or CH₃; G, p, R¹, R², R³, R⁵, m, n, w, y, z and (y+z) have the meanings given under formula (IV).

143. The formulation as claimed in claim 142, wherein the hydrolyzable residue is at least one representative of the group alkyl ester, aminoalkyl ester, hydroxyalkyl ester, aminohydroxyalkyl ester or amide.

144. The formulation as claimed in claim 107, wherein the nonionic copolymer a₃) is at least one representative of general formula (VI) 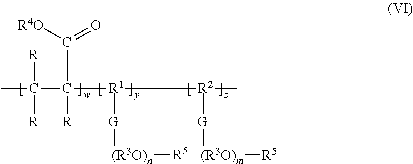
wherein R⁴ denotes at least one C₁-C₁₀ alkyl or C₂-C₂₀ hydroxyalkyl residue and the residues G, p, R, R¹, R², R³, c, R⁴, R⁵ and m, n, w, y, z and (y+z) have the meanings given under formulas (IV) and (V).

145. The formulation as claimed in claim 144, Wherein p=4, R⁴═C₂H₄OH or C₃H₆OH, each of the residues R⁵ is H;
m is from 5 to 30;
n is from 31 to 250;
w is from 1.5 to 30;
y is from 0 to 1;
z is from 0 to 1; and
(y+z)>0.

146. The formulation as claimed in claim 141, wherein the molar ratio of w to the sum (y+z) is 1:1 to 20:1.

147. The formulation as claimed in claim 107, wherein the copolymer a₃) is a nonionic polyether-polyester copolymer.

148. The formulation as claimed in claim 93, wherein the structural units (I), (II), (III) of component b) are of formulas 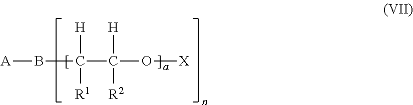
wherein:
A is identical or different and is a substituted or unsubstituted aromatic or heteroaromatic compound with 5 to 10 carbon atoms;
wherein
B identical or different and is by N, NH or O; wherein
n is 2, if B is N, and is 1, if B is NE or 0;
wherein
R¹ and R² are independently of one another identical or different and represented by a linear or branched C₁- to C₁₀-alkyl residue, C₅- to C₈-cycloalkyl residue, aryl residue, heteroaryl residue or H
with
a identical or different and represented by an integer from 1 to 300 with X
identical or different and represented by a linear or branched C₁- to C₁₀-alkyl residue, C₅- to C₈-cycloalkyl residue, aryl residue, heteroaryl residue or H 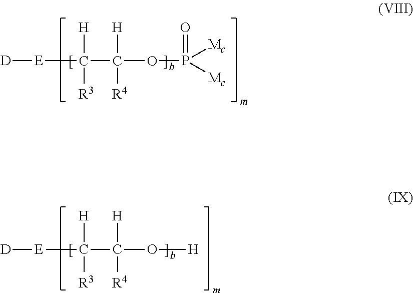
for (VIII) and (IX) in each case:
wherein
D identical or different and represented by a substituted or unsubstituted heteroaromatic compound with 5 to 10 carbon atoms;
wherein
E identical or different and represented by N, NH or O; wherein
m is 2 if E is N, and m is 1, if E is NH or O;
wherein
R³ and R⁴ are independently of one another, identical or different and represented by a linear or branched C₁- to C₁₀-alkyl residue, C₅- to C₈-cycloalkyl residue, aryl residue, heteroaryl residue or H with b identical or different and represented by an integer from 0 to 300
with
M independently of one another an alkali, alkaline-earth, ammonium or an organic ammonium acid ion and/or H,
with
c=1 or in the case of an alkali ion=½.

149. The formulation as claimed in claim 55, wherein component b) contains another structural unit (X), which is represented by the following formula 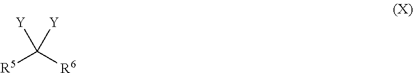
with
Y, independently of one another, identical or different and represented by (VII), (VIII), (IX) or further constituents of the polycondensation product b)
with
R⁵ identical or different and represented by H, CH₃, COOH or a substituted or unsubstituted aromatic or heteroaromatic compound with 5 to 10 carbon atoms
with
R⁶ identical or different and represented by II, CH₃, COOH or a substituted or unsubstituted aromatic or heteroaromatic compound with 5 to 10 carbon atoms.

150. The formulation as claimed in claim 149, wherein R⁵ and R⁶ in structural unit (X) of component b), independently of one another, identical or different, are represented by H, COOH and/or methyl.

151. The formulation as claimed in claim 92, wherein the molar ratio of the structural units [(VII)+(VIII)+(IX)]:(X) in component b) is 1:0.8 to 3.

152. The formulation as claimed in claim 92, wherein the molar ratio of the structural units (VII):[(VIII)+(IX)] in component b) is 1:15 to 15:1 and preferably 1:10 to 10:1.

153. The formulation as claimed in claim 92, wherein the molar ratio of the structural units (VIII):(IX) in component b) is 1:0.005 to 1:10.

154. The formulation as claimed in claim 92, wherein the polycondensation product b) is in aqueous solution, which contains 2 to 90 wt. % water and 98 to 10 wt % dissolved dry matter.

155. The formulation as claimed in claim 92, wherein component a) is contained in proportions from 5 to 95 wt %, preferably from 10 to 60 wt. % and especially preferably from 15 to 40 wt. %, in each case relative to the total formulation.

156. The formulation as claimed in claim 92, wherein component b) is contained in proportions from 5 to 100 wt. %, preferably from 10 to 60 wt % and especially preferably from 15 to 40 wt. %, in each case relative to the total formulation.

157. The formulation as claimed in claim 92, wherein in addition to components a) and b), at least one antifoaming agent is used as component c) author a component d) with surface active action, wherein components c) and d) are structurally different one another.

158. The formulation as claimed in claim 157, wherein the antifoaming component c) is at least one representative of the group mineral oil, vegetable oil, silicone oil, silicone-containing emulsions, fatty acid, fatty acid ester, organically modified polysiloxane, borate ester, alkoxylate, polyoxyalkylene copolymer, ethylene oxide (EO)-propylene oxide (PO) block polymer, acetylenic diol with antifoaming properties, phosphoric acid ester of formula P(O)(O—R₈)₃₋ₓ(O—R₉)ₓ in which P=phosphorus, O=oxygen and R₈ and R₉ independently of one another denote a C₂₋₂₀ alkyl or an aryl group and x=0, 1 or 2.

159. The formulation as claimed in claim 157, wherein the antifoaming component c) is at least one representative of the group trialkylphosphate, polyoxypropylene copolymer and/or glycerin alcohol acetate.

160. The formulation as claimed in claim 157, wherein the antifoaming component c) is triiso-butylphosphate.

161. The formulation as claimed in claim 157, wherein the antifoaming component c) is a mixture of a trialkylphosphate and a polyoxypropylene copolymer.

162. The formulation as claimed in claim 157, wherein component d) is at least one member selected from the group ethylene oxide/propylene oxide (EO/PO) block copolymer, styrene/maleic acid copolymer, fatty acid alcohol alkoxylate, alcohol ethoxylate R₁₀-(EO)—H with R₁₀=an aliphatic hydrocarbon group with 1 to 25 carbon atoms, acetylenic diol, monoalkylpolyalkylene, ethoxylated nonylphenol, alkylsulfate, alkyl ethersulfate, alkyl ethersulfonate and alkyl ether carboxylate.

163. The formulation as claimed in claim 157, wherein component d) comprises an alcohol with a polyalkylene group, wherein the polyalkylene group has a carbon chain length of 2 to 20 carbon atoms.

164. The formulation as claimed in claim 163, wherein the polyalkylene group has a carbon chain length of 3 to 12 carbon atoms.

165. The formulation as claimed in claim 157, wherein the antifoaming component c) is contained in free form, bound to the dispersant component a) or in a mixture of these two forms.

166. The formulation as claimed in claim 157, wherein at least one of the antifoaming component c) or the surface active component d) is contained in an amount of from 0.01 to 10 wt. % relative to the weight of the total formulation.

167. The formulation as claimed in claim 157, wherein at least one of the antifoaming agent c) or the surface active component d) are independently of one another contained in an amount of from 0.01 to 5 wt. % relative to the weight of the total formulation.

168. The formulation as claimed in claim 92, further comprising as component e) at least one compound selected from the group consisting of low-charge polymer, a neutral polymer and polyvinyl alcohol.

169. The formulation as claimed in claim 168, wherein component e) is present in an amount of from 1 to 50 wt. % relative to the weight of the total formulation.

170. The formulation as claimed in claim 168, wherein the low-charge polymer is branched and the side chain contains a polyether or a polyester.

171. The formulation as claimed in claim 168, wherein the low-charge polymer is a polycarboxylate ether or a polycarboxylate ester.

172. The formulation as claimed in claim 168, wherein the low-charge polymer e) is constructed from at least one monomer selected from the group consisting of polyether monoacrylate, polyether monomethacrylate, polyether monoallyl ether, polyether monomaleate and monovinylated polyether.

173. The formulation as claimed in claim 172, wherein the polyether is an alkylene oxide polymer with a molecular weight from 500 to 10,000.

174. The formulation as claimed in claim 173, wherein the alkylene oxide is at least one member selected from the group consisting of ethylene oxide, propylene oxide and butylene oxide.

175. The formulation as claimed in claim 168, wherein the low-charge polymer e) is constructed from at least one monomer selected from the group consisting of a polypropylene-glycol acrylate, a polypropylene-glycol methacrylate, a polyethylene-glycol acrylate, a polyethylene-glycol methacrylate, a polypropylene-glycol-monovinyl ether, a polythylene-glycol-monovinyl ether, an alkoxy-polyethylene-glycol-acrylate, an aryloxy-polythylene-glycol acrylate, an alkoxy-polyethylene-glycol methacrylate; an aryloxy-polythylene-glycol methacrylate, an alkoxy-polyethyleneglycol-monovinyl ether, an aryloxy-polythylene-glycol-monovinyl ether, an acrylate, a methacrylate, a monovinyl ether of an oxyethylene and oxypropylene block copolymer, a monovinyl ether of an oxyethylene and oxypropylene randomized copolymer, a polypropylene-glycol-allyl ether, a polyethylene-glycol-allyl ether, polyethylene-glycol-monomaleate and polypropylene-glycol-monomaleate.

176. The formulation as claimed in claim 168, wherein the low-charge polymer e) bears a carboxylic acid group, preferably selected from the group acrylic acid, methacrylic acid, maleic acid, fumaric acid, itaconic acid or anhydrides thereof.

177. The formulation as claimed in claim 168, wherein the low-charge polymer e) bears a sulfonic acid group selected from the group consisting of 2-acrylamide-2-methylpropanesulfonic acid, vinylsulfonic acid, allyl ethersulfonic acid, 2-sulfoethylmethacrylic acid, styrene-sulfonic acid, and methallylsulfonic acid, or sodium, potassium and ammonium salts thereof.

178. The formulation as claimed in claim 168, wherein the neutral polymer e) is constructed from neutral monomer building block containing up to 5 carbon atoms selected from the group consisting of acrylic acid alkyl ester, methacrylic acid alkyl ester and hydroxyalkyl esters

179. the formulation as claimed in claim 168, wherein the neutral polymer e) is selected from the group consisting of hydroxyethyl acrylate, hydroxypropyl acrylate, hydroxyethylmethacrylate, hydroxypropylmethyacrylate, vinyl acetate, N-vinylpyrrolidone, N-vinylcaprolactam, styrene and methylstyrene.

180. The formulation as claimed in claim 92, wherein the compound with dispersing properties is present in an amount from 1.0 to 40 wt. % relative to the solids content of the dispersing component.

181. The formulation as claimed in claim 92, further comprising a processing aid preferably member selected from the group consisting of selected from the group consisting of an extender, an emulsifier, a binder, a wetting agent, a diluent, a dye, a biocide, a preservative, a stabilizer, an antisettling agent, a marking agent and a separating agent.

182. The formulation as claimed in claim 181, wherein the processing aid is present in an amount of up to 35 wt. % relative to the total formulation.

183. An article of manufacture comprising a cellulose-containing material preserved with the formulation as claimed in claim 92.

184. A method comprising applying the foil mulation as claimed in claim 92 to a cellulose containing material in an amount sufficient to protect or preserve the cellulose containing material.

185. An article of manufacture according to claim 183, wherein the cellulose-containing material is wood.

186. The method of claim 184, wherein the cellulose-containing material is wood.

187. The method as claimed in claim 184, wherein the formulation is applied to the wood by pressure treatment.
